(19) United States
(12) Patent Application Publication
(10) Pub. No.: US 2012/0148994 A1
(43) Pub. Date: Jun. 14, 2012

(54) HUMAN BODY PARTIAL MANIKIN

(75) Inventors: Takatsu Hori, Ikeda-shi (JP); Byung Joon Lee, Seoul (KR)

(73) Assignees: SINI INC., Seoul (KR); TMC CORPORATION, Osaka (JP)

(21) Appl. No.: 13/313,248

(22) Filed: Dec. 7, 2011

(30) Foreign Application Priority Data
Dec. 14, 2010 (JP) 2010-278418

(51) Int. Cl. G09B 23/28

(52) U.S. Cl. 434/272

(57) ABSTRACT

A human body partial manikin having the same flexibility, elasticity, and texture as the human body is provided. And a manikin which has a feeling when it is cut open by means of a scalpel or scissors, similar to a feeling when an actual operation is performed by using a human body and is optimum for the anatomical practice of an inguinal hernia is provided. Accordingly, the human body partial manikin includes a skin portion which represents a skin layer on the surface of a lower abdomen of a human body, an abdominal external oblique muscle portion, an abdominal internal oblique muscle portion, a transverse abdominal muscle portion, a fascia transversalis portion, a fascia extraperitoneal portion, a peritoneum portion, and an abdominal cavity portion toward the inside of the manikin, wherein these respective portions are formed of a silicone resin.

This nonprovisional application is based on Japanese Patent Application No. 2010-278418 filed with the Japan Patent Office on Dec. 14, 2010, the entire contents of which are hereby incorporated by reference.

### BACKGROUND OF THE INVENTION

1. Field of the Invention

The present invention relates to a human body partial manikin used in the anatomical practice of an inguinal hernia. More specifically, the present invention relates to a human body partial manikin which represents the structure of a lower abdomen of a human body.

2. Description of the Background Art

To be able to perform surgical operations, it is necessary to learn medical theories, to perform anatomical practices, to perform operation viewing, and to have practices under the same conditions as actual operations. Accordingly, to ensure the number of samples used in anatomical practices, manikins are used in place of human bodies to ensure anatomical practice opportunities. Included in the human body manikin are a whole body manikin and a partial manikin which represents only part of a human body, the partial manikin which can be simulated in any place and enables finer representation being used often.

The human body manikin is manufactured by cast-molding plastics such as an acrylic resin, an ABS resin, and a polycarbonate resin. The manikin manufactured by molding plastics is transparent and enables its inside to be observed, but due to the hard plastic material, it is impossible to cut open it by means of a scalpel or scissors to isolate an internal organ manikin from its inside.

According to Japanese Patent Application Laid-Open (JP-A) No. 06-80758, a human body manikin made of polyurethane has been known. It is described that this manikin, which has moderate elasticity and is excellent in bendability, is similar in physical properties to the soft tissue of a human body. However, polyurethane having poor adhesiveness is difficult to attach an internal organ manikin which is separately molded of polyurethane, with the result that processing suitability after molding is low. In addition, it is important that the human body manikin used in an anatomical practice has a feeling similar to a feeling when an actual operation is performed by using a living body, but in the polyurethane manikin, a feeling when it is cut open by a scalpel or scissors to isolate the internal organ manikin attached to its inside is different from a feeling when an operation is performed on a living body.

### SUMMARY OF THE INVENTION

A human body partial manikin having the same structure as a human body and having the same flexibility, elasticity, and texture as the human body is provided. In addition, a human body partial manikin which has a feeling when it is cut open by means of a scalpel or scissors, similar to a feeling when an actual operation is performed by using a human body and is optimum for the anatomical practice of an inguinal hernia is provided.

Therefore, a human body partial manikin of the present invention is used in the anatomical practice of an inguinal hernia and represents the structure of a lower abdomen of a human body. The human body partial manikin includes a skin portion enclosing a gauze, and an abdominal external oblique muscle portion which is stacked onto the skin portion, is coupled to the skin portion in a peripheral edge portion of a region onto which the abdominal external oblique muscle portion is stacked, and encloses the gauze. Further, the human body partial manikin includes an abdominal internal oblique muscle portion which has the same area as the abdominal external oblique muscle portion, is stacked onto the abdominal external oblique muscle portion, is coupled to a peripheral edge portion of the abdominal external oblique muscle portion, and encloses the gauze, and a transverse abdominal muscle portion which is smaller than the abdominal internal oblique muscle portion, is stacked onto part of the abdominal internal oblique muscle portion, and is coupled to a peripheral edge portion of the abdominal internal oblique muscle portion.

In addition, the human body partial manikin includes a fascia transversalis portion which has the same area as the abdominal internal oblique muscle portion, is stacked onto the abdominal internal oblique muscle portion across the transverse abdominal muscle portion, and is coupled to a peripheral edge portion of the abdominal internal oblique muscle portion, and a fascia extraperitoneal portion which has the same area as the fascia transversalis portion, is stacked onto the fascia transversalis portion, and is coupled to a peripheral edge portion of the fascia transversalis portion. Further, the human body partial manikin includes a peritoneum portion which has the same area as the fascia extraperitoneal portion, is stacked onto the fascia extraperitoneal portion, is coupled to a peripheral edge portion of the fascia extraperitoneal portion, and has an intestinal canal portion, and an abdominal cavity portion which has the same area as the peritoneum portion, and is stacked onto the peritoneum portion, and these respective portions are formed of a silicone resin.

The abdominal external oblique muscle portion, the abdominal internal oblique muscle portion, and the transverse abdominal muscle portion are preferably a film body, and the intestinal canal portion preferably passes through the fascia extraperitoneal portion and the fascia transversalis portion. In addition, the skin portion, the abdominal external oblique muscle portion, and the abdominal internal oblique muscle portion preferably have a cut open portion. The silicone resin is preferably formed of 65% by mass to 80% by mass of polydimethylsiloxane, 1% by mass to 30% by mass of a crosslinking agent containing at least one of tetraethoxysilane and ethyl silicate, 3% by mass to 15% by mass of a tin catalyst containing di-n-butyltin dilaurate, and 1% by mass to 10% by mass of powder silica.

The skin portion preferably includes an epidermis portion, an endothelium portion, and a subcutaneous fat portion, and the partial manikin preferably includes an inguinal ligament portion between the abdominal external oblique muscle portion and the abdominal internal oblique muscle portion. In addition, the partial manikin preferably has a nerve portion between the abdominal internal oblique muscle portion and the abdominal external oblique muscle portion, at least one nerve portion passing through the abdominal internal oblique muscle portion, the fascia transversalis portion, and the fascia extraperitoneal portion. The partial manikin preferably includes a rectus abdominis muscle portion, an inferior epigastric vessel portion, a pubic bone portion, and a pectineal ligament portion between the fascia transversalis portion and the fascia extraperitoneal portion. The partial manikin preferably includes a spermatic cord portion which passes through the fascia extraperitoneal portion and the fascia transversalis portion and projects outward of the partial manikin from the abdominal internal oblique muscle portion, the spermatic cord portion having a ductus deferens portion and a testicular blood vessel portion. In addition, the partial manikin preferably includes a pelvis portion between the peritoneum portion and the abdominal cavity portion.

By such a structure, the human body partial manikin of the present invention has the same structure as a human body, and has the same flexibility, elasticity, and texture as the human body. In addition, the human body partial manikin has a feeling when it is cut open by means of a scalpel or scissors, similar to a feeling when an actual operation is performed by using a human body. Therefore, it is optimum as a human body partial manikin used in the anatomical practice of an inguinal hernia.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A to 1D and FIGS. 2A to 2D are explanatory views showing members structuring a human body partial manikin of the present invention.

FIG. 3 is a perspective view of an abdominal internal oblique muscle portion 3 on which three nerve portions 31, 32, and 33 are arranged.

FIG. 4 is a perspective view of a peritoneum portion 12.

FIG. 5 is a perspective view of the completed human body partial manikin seen from a skin portion side.

FIG. 6 is a perspective view of the completed human body partial manikin seen from an abdominal cavity portion side.

FIG. 7 is a perspective view of the cut open human body partial manikin.

FIG. 8 is a perspective view showing the human body partial manikin having a pelvis portion.

### DESCRIPTION OF THE PREFERRED EMBODIMENTS

A human body partial manikin of the present invention represents the structure of a lower abdomen and is used in the anatomical practice of an inguinal hernia. Anatomically, an inguina refers to the base portion of legs, and a state that an organ or tissue prolapses to the base portion of legs is called an inguinal hernia, which is also called an abdominal hernia since there are many cases in which an intestinal canal which should be originally in a peritoneum prolapses to the inguina. In addition, males who have a weaker inguinal structure than females in physical structure have a fascia which is likely to be ruptured, so that 80% to 90% of inguinal hernias occur in males. Since the intestinal canal prolapses to the base portion of legs, the inguinal hernia cannot be recovered completely by medicines, thereby requiring treatment by an operation. The partial manikin of the present invention is used in the anatomical practice of an inguinal hernia, and enables the practice with a feeling similar to a feeling in an actual operation. In addition, the partial manikin enables the practice in any place and is provided with the same fine representation as an actual human body structure, so that it enables exact medical learning and has a high practice effect.

The human body partial manikin of the present invention includes a skin portion which represents a skin layer on the surface of the lower abdomen of a human body, and includes an abdominal external oblique muscle portion, an abdominal internal oblique muscle portion, a transverse abdominal muscle portion, a fascia transversalis portion, a fascia extraperitoneal portion, a peritoneum portion, and an abdominal cavity portion toward the inside of the manikin, wherein these respective portions are formed of a silicone resin. As the silicon resin, the following silicone resin is preferable, and herein, the silicone resin is also called a silicone resin A. In the human body partial manikin of the present invention, main components are formed of silicone resin A, so that the partial manikin has the same flexibility, elasticity, and texture as an organ structuring a human body and has a feeling when it is cut open by means of a scalpel or scissors, similar to a feeling when an actual operation is performed by using a human body, whereby it has reality and is optimum as a human body partial manikin used in the anatomical practice of an inguinal hernia.

Silicone resin A is preferably formed of polydimethylsiloxane, a crosslinking agent, a tin catalyst, and powder silica. Polydimethylsiloxane (CAS number: 63148-62-9) having a mass average molecular weight of several thousand to several hundred thousand can be used, but to ensure the elasticity and texture of the formed silicone resin, polydimethylsiloxane having a mass average molecular weight of 10,000 to 400,000 can be preferably used. In addition, to enhance the elasticity and texture of the formed silicone resin, the mixing amount of polydimethylsiloxane is preferably 65% by mass or more and more preferably 70% by mass or more of the total composition of the silicone resin. On the other hand, to lower the viscosity of the polydimethylsiloxane-containing liquid and to promote a curing reaction, the mixing amount of polydimethylsiloxane is preferably 80% by mass or less and more preferably 75% by mass or less of the total composition of the silicone resin.

As the crosslinking agent, methyltrimethoxysilane, methyltriethoxysilane, ethyltrimethoxysilane, ethyltriethoxysilane, tetraethoxysilane, tetrapropoxysilane, vinyltrimethoxysilane, vinyltriphenoxysilane, vinyltriethoxysilane, allyltriethoxysilane, vinyltriisopropoxysilane, vinyltrisisopropenoxysilane, and so on can be used, but to enhance the curability and handleability of polydimethylsiloxane and surface characteristics of the formed resin, tetraethoxysilane (CAS number: 78-10-4) is preferable. In addition, when ethyl silicate (CAS number: 11099-06-2) is used as the crosslinking agent or is used together with the crosslinking agent, surface characteristics of the formed silicone resin are excellent.

To promote the curing reaction of polydimethylsiloxane and to enhance the flexibility, elasticity, and texture of the silicone resin, the mixing amount of the crosslinking agent is preferably 1% by mass or more, more preferably 3% by mass or more, and particularly preferably 5% by mass or more of the total composition of the silicone resin. On the other hand, to properly inhibit the curing reaction of polydimethylsiloxane and to moderately hold the flexibility, elasticity, and texture of the silicone resin, the mixing amount of the crosslinking agent is preferably 30% by mass or less, more preferably 28% by mass or less, and particularly preferably 25% by mass or less of the total composition of the silicone resin.

Polydimethylsiloxane is preferable in that when it is diluted with a solvent, the viscosity of the polydimethylsiloxane-containing liquid is prevented from being increased to promote a crosslinking reaction. An aliphatic hydrocarbon solvent and an aromatic hydrocarbon solvent are preferable. The aliphatic hydrocarbon solvent is preferably pentane, hexane, heptane, octane, an isoparaffin, or a normal paraffin. Meanwhile, the aromatic hydrocarbon solvent is preferably toluene or xylene. In addition, a petroleum solvent, short-chain linear siloxanes such as hexamethyldisiloxane and octamethyltrisiloxane, and cyclic polysiloxanes such as octamethylcyclotetrasiloxane and decamethylcyclopentasiloxane can also be preferably used. In view of operability and handleability, the concentration of the solution is preferably 15% by mass to 65% by mass, and more preferably 25% by mass to 50% by mass. Since the crosslinking agent is likely to cause hydrolysis, any moisture is preferably sufficiently removed before the crosslinking agent is mixed.

In a combination of polydimethylsiloxane and the crosslinking agent, to appropriately promote the curing reaction, tin catalysts are preferable, and among the tin catalysts, an organic acid salt of tin is more preferable. Examples of such tin catalysts include dibutyltin dilaurate, dibutyltin diacetate, dibutyltin dioctate, dimethyltin dineodecanoate, dioctyltin dilaurate, isobutyltin triceroate, dimethyltin dibutyrate, triethyltin tartrate, bis(acetoxydibutyltin) oxide, and bis(lauroxydibutyltin) oxide, but to enable the formed silicone resin to have moderate elasticity and texture, di-n-butyltin dilaurate (CAS number: 77-58-7) is more preferable.

To promote the curing reaction, the mixing amount of the tin catalyst is preferably 3% by mass or more, more preferably 5% by mass or more, and particularly preferably 7% by mass or more of the total composition of the silicone resin. On the other hand, to increase the pot life of the polydimethylsiloxane-containing liquid and to enhance the operability, the mixing amount of the tin catalyst is preferably 15% by mass or less, more preferably 12% by mass or less, and particularly preferably 10% by mass or less of the total composition of the silicone resin.

To increase the mechanical strength of the silicone resin, the powder silica (CAS number: 7631-86-9) is preferably mixed. Examples of the powder silica include wet silica powder and dry silica (fumed silica) powder. Since wet silica is inexpensive, the silicone resin into which wet silica is mixed is advantageous in terms of cost, but since wet silica has 1% by mass to 15% by mass of adsorbed water on the particle surface, the compatibility between wet silica and the silicone resin having high water repellency is low, with the result that characteristics such as the plasticity of the silicone resin tend to be changed with time. Therefore, as the powder silica, the fumed silica powder manufactured by a dry method with such demerits being lessened is preferable. To obtain a reinforcing effect, the mixing amount of the powder silica is preferably 1% by mass to 10% by mass, and more preferably 3% by mass to 7% by mass of the total composition of the silicone resin.

The respective components are mixed to cause the curing reaction for forming the silicone resin. To ensure the pot life, before curing, the reaction components are preferably held in different containers. In addition, after the respective components are mixed, the mixture can be heated, if necessary, to promote the curing reaction. In addition, a coloring agent, a stabilizer, a surfactant, and a reaction inhibitor are mixed into the silicone resin, if necessary. As the reaction inhibitor, a nitrogen-containing compound, a phosphorus compound, and an unsaturated alcohol are preferable.

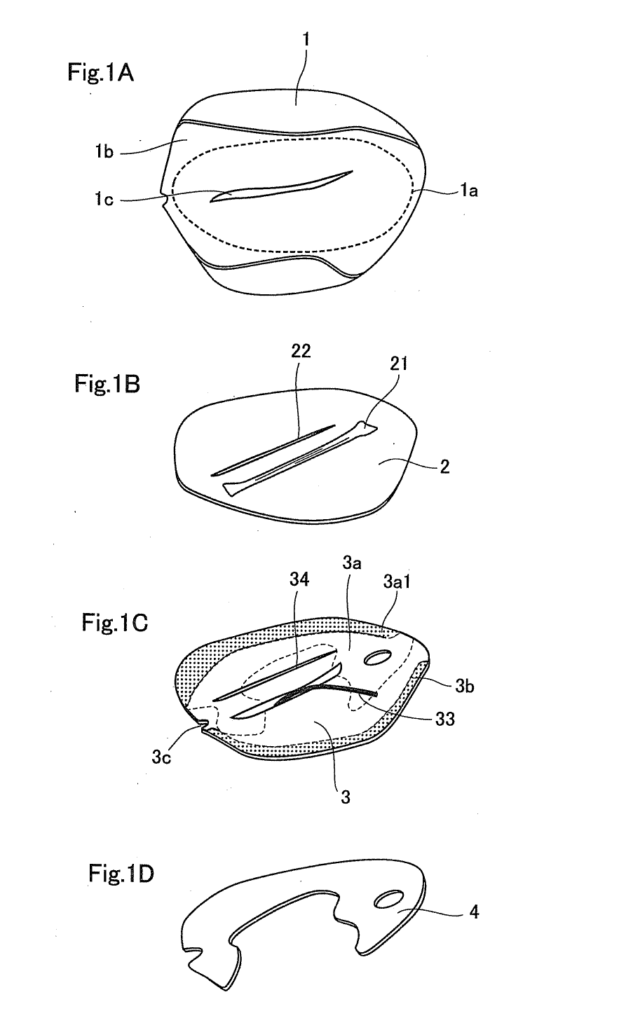

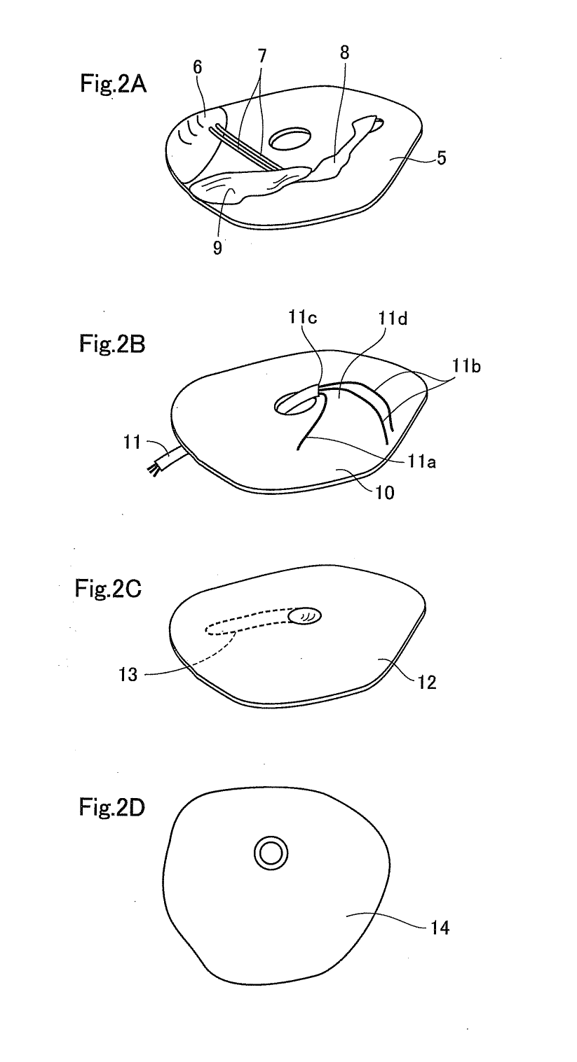

FIGS. 1A to 1D and FIGS. 2A to 2D are explanatory views showing members structuring the human body partial manikin of the present invention. The size of each member is preferably the same as a corresponding portion in a human body in view of reality. FIG. 1A is a perspective view of a skin portion 1. The skin portion can be formed, e.g., by applying silicone resin A onto the inside of a mold, stacking a gauze before the resin is cured, applying silicone resin A onto the gauze, and releasing cured silicone resin A from the mold. The skin portion can be represented by a single film body enclosing one gauze, but to be similar to the structure of a human body and to improve the reality of a practice, the skin portion preferably includes an epidermis portion, an endothelium portion, and a subcutaneous fat portion. The epidermis portion is formed in such a skin portion, e.g., by applying silicone resin A onto the inside of a mold, stacking a gauze before the resin is dried to cure, and applying silicone resin A onto the gauze and curing the resin. Thereafter, the same operation is repeated to stack the endothelium portion and the subcutaneous fat portion onto the epidermis portion.

The gauze is a thin and plain weaved cloth including threads made of cotton which is natural cellulose. The gauze is enclosed in the skin portion cut open by a scalpel or scissors, so that the skin portion can have a feeling when it is cut open by a scalpel or scissors, similar to a feeling when an actual operation is performed by using a human body, whereby a practice with reality can be realized. In addition, since a mechanical strength is increased, shape retaining force is improved, no accidental dents are caused, and restoration can be made easy even when any dent is caused. The gauze is preferably used as a single layer.

The thickness of the threads forming the gauze is different according to the number of layers structuring the skin portion, but to enhance the reality at the time of a practice, No. 20 count or more is preferable, and No. 40 count or more is more preferable. On the other hand, to improve the shape retaining force, the thickness of the threads is preferably No. 80 count or less, and more preferably No. 70 count or less. To enhance the reality at the time of a practice, the total number of needling of warp threads and weft threads at the time of forming the gauze is preferably 130 needles/25.4 mm or less, and more preferably 110 needles/25.4 mm or less. On the other hand, to enhance the shape retainability, the number of needling is preferably 40 needles/25.4 mm or more, and more preferably 50 needles/25.4 mm or more.

The abdominal external oblique muscle portion can be formed, e.g., by applying silicone resin A onto the inside of a mold or pouring the silicone resin into the mold, stacking the gauze before the resin is dried to cure, applying or pouring silicone resin A onto the gauze, and releasing cured silicone resin A from the mold. To be similar to the structure of a human body and to improve the reality of a practice, an inguinal ligament portion is preferably provided between the abdominal external oblique muscle portion and the abdominal internal oblique muscle portion. FIG. 1B is a perspective view of an abdominal external oblique muscle portion 2 on which an inguinal ligament portion 21 is arranged. The inguinal ligament portion can be obtained, e.g., by pouring silicone resin A into a mold, and taking cured silicone resin A out of the mold. As shown in FIG. 1B, for instance, formed inguinal ligament portion 21 is bonded to abdominal external oblique muscle portion 2, with a top surface at the time of pouring silicone resin A into the mold as a bonding surface. According to such a form, inguinal ligament portion 21 in a predetermined shape reflecting the inside shape of the mold can be formed onto abdominal external oblique muscle portion 2. As used herein, a back side is the surface directing in the inside direction of the partial manikin, and is the top surface of abdominal external oblique muscle portion 2 of FIG. 1B. In addition, the inguinal ligament portion can also be formed by making each of one side and the other side of the inguinal ligament portion in the mold and bonding the two sides to each other. Other members are manufactured in the same manner.

As shown in FIG. 1A, abdominal external oblique muscle portion 2 is stacked onto a region 1a on the back side of skin portion 1, and is coupled to skin portion 1 to a peripheral edge portion of region 1a onto which abdominal external oblique muscle portion 2 is stacked. A peripheral edge portion of abdominal external oblique muscle portion 2 is coupled to skin portion 1, so that when the skin portion of the manikin is cut open by means of a scalpel or the like, the abdominal external oblique muscle portion located on the back side of the skin portion can be observed and touched by fingers, thereby enabling the practice effect to be increased.

A silicone adhesive can be preferably used for coupling the skin portion to the abdominal external oblique muscle portion and for coupling the abdominal external oblique muscle portion to the inguinal ligament portion. The silicone adhesive has organopolysiloxane as a main component, and there are a condensation curing type silicone adhesive and an addition curing type silicone adhesive. The condensation curing type silicone adhesive is a one-component type silicone adhesive made by mixing organopolysiloxane having a hydroxyl group at its end with the crosslinking agent. Since the condensation curing type silicone adhesive is moisture-curable, the applied adhesive reacts with moisture in the air, and is cured from its surface, thereby forming a cured layer having rubber elasticity. The condensation curing type silicone adhesive is classified according to a free gas (; acetone, an oxime, acetic acid, or an alcohol) generated at the time of a condensation reaction. On the contrary, the addition curing type silicone adhesive is a two-component type silicone adhesive divided into organopolysiloxane having a vinyl group at its end and the crosslinking agent, and is cured by using the catalyst. The addition curing type silicone adhesive is preferable because it has a higher curing speed than the condensation curing type silicone adhesive and generates no free gas.

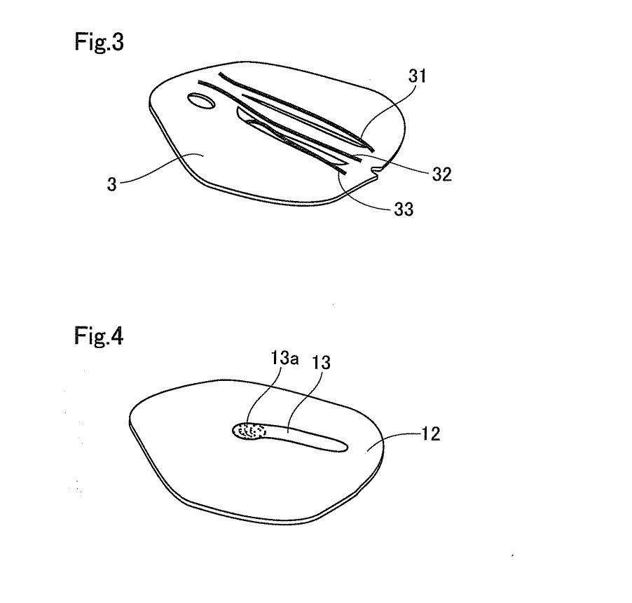

To be similar to the structure of a human body and to improve the reality of a practice, the abdominal internal oblique muscle portion has a nerve portion between the abdominal internal oblique muscle portion and the abdominal external oblique muscle portion. FIG. 3 is a perspective view of an abdominal internal oblique muscle portion 3 on which three nerve portions 31, 32, and 33 are arranged. In the example shown in FIG. 3, of the three nerve portions, two nerve portions 31 and 32 are arranged on the back side of abdominal internal oblique muscle portion 3 (; in the arrangement shown in FIG. 3, the upper surface of abdominal internal oblique muscle portion 3), and one nerve portion 33 passes through abdominal internal oblique muscle portion 3 from the back side midway and extends to the front side of abdominal internal oblique muscle portion 3 (; in the arrangement shown in FIG. 3, the lower surface of abdominal internal oblique muscle portion 3). Each of the nerve portions is a linear body and can be a hose-like hollow body. The nerve portions are preferably formed of a silicone resin such as silicone resin A. The hose-like hollow body can be formed by extrusion molding with a mandrel.

The abdominal internal oblique muscle portion can be formed, e.g., by applying silicone resin A onto the inside of a mold or pouring the silicone resin into the mold, stacking the gauze before the resin is dried to cure, applying or pouring silicone resin A onto the gauze, and releasing cured silicone resin A from the mold. FIG. 1C is a perspective view when abdominal internal oblique muscle portion 3 shown in FIG. 3 is reversely arranged. The top surface of abdominal internal oblique muscle portion 3 in FIG. 1C is a back side, and corresponds to the surface directing in the inside direction of the partial manikin. Abdominal internal oblique muscle portion 3 shown in FIG. 1C has the same area as abdominal external oblique muscle portion 2 shown in FIG. 1B, is stacked onto the back side of abdominal external oblique muscle portion 2, and is coupled to the peripheral edge portion of abdominal external oblique muscle portion 2. The peripheral edge portion of abdominal external oblique muscle portion 2 is coupled to abdominal internal oblique muscle portion 3, so that when abdominal external oblique muscle portion 2 of the manikin is cut open by means of a scalpel or the like, abdominal internal oblique muscle portion 3 located on the back side of abdominal external oblique muscle portion 2 can be observed and touched by fingers, thereby enabling the practice effect to be increased. The silicone adhesive can be preferably used for coupling abdominal internal oblique muscle portion 3 to abdominal external oblique muscle portion 2 and for coupling abdominal internal oblique muscle portion 3 to nerve portions 31, 32, and 33. Abdominal external oblique muscle portion 2 is coupled to abdominal internal oblique muscle portion 3, so that inguinal ligament portion 21 is arranged between abdominal external oblique muscle portion 2 and abdominal internal oblique muscle portion 3.

FIG. 1D is a perspective view of a transverse abdominal muscle portion 4. The transverse abdominal muscle portion can be formed, e.g., by applying silicone resin A onto the inside of a mold or pouring the silicone resin into the mold, and releasing cured silicone resin A from the mold. The top surface of transverse abdominal muscle portion 4 in FIG. 1D is a back side, and corresponds to the surface directing in the inside direction of the partial manikin. As shown in FIG. 1D, preferably, transverse abdominal muscle portion 4 is smaller than abdominal internal oblique muscle portion 3 shown in FIG. 1C, is stacked onto a region 3a in abdominal internal oblique muscle portion 3, and is coupled to a peripheral edge portion 3a1 of abdominal internal oblique muscle portion 3. Peripheral edge portion 3a1 of abdominal internal oblique muscle portion 3 is coupled to transverse abdominal muscle portion 4, so that when abdominal internal oblique muscle portion 3 of the manikin is cut open by means of a scalpel or the like, transverse abdominal muscle portion 4 located on the back side of abdominal internal oblique muscle portion 3 can be observed and touched by fingers, thereby enabling the practice effect to be increased. The silicone adhesive can be preferably used for coupling abdominal internal oblique muscle portion 3 to transverse abdominal muscle portion 4.

The fascia transversalis portion can be formed, e.g., by applying silicone resin A onto the inside of a mold or pouring silicone resin A into the mold, and releasing cured silicone resin A from the mold. The fascia transversalis portion can also enclose the gauze. The fascia transversalis portion enclosing the gauze can be formed by applying silicone resin A onto the mold or pouring silicone resin A into the mold, stacking the gauze before the resin is dried to cure, and applying or pouring silicone resin A onto the gauze.

To be similar to the structure of a human body and to improve the reality of a practice, the fascia transversalis portion preferably has a rectus abdominis muscle portion, an inferior epigastric vessel portion, a pubic bone portion, and a pectineal ligament portion. FIG. 2A shows an example in which a rectus abdominis muscle portion 6, an inferior epigastric vessel portion 7, and a pubic bone portion 8 are bonded to a fascia transversalis portion 5 in this order, and finally, a pectineal ligament portion 9 is formed. The silicone adhesive can be preferably used for bonding rectus abdominis muscle portion 6, inferior epigastric vessel portion 7, and pubic bone portion 8 to fascia transversalis portion 5.

The rectus abdominis muscle portion can be formed, e.g., by pouring silicone resin A into a mold, and taking cured silicone resin A out of the mold. For instance, the formed rectus abdominis muscle portion is bonded to the fascia transversalis portion, with the top surface when silicone resin A is poured into the mold as a bonding surface.

According to such a form, the rectus abdominis muscle portion in a predetermined shape reflecting the inside shape of the mold can be formed in the fascia transversalis portion. The rectus abdominis muscle portion can also be formed, e.g., by pouring silicone resin A into two molds separated to the left and right, and releasing cured silicone resin A from the molds.

In the example shown in FIG. 2A, inferior epigastric vessel portion 7 includes an inferior epigastric artery and an inferior epigastric vein. Inferior epigastric vessel portion 7 is a linear body, and can be a hose-like hollow body. The inferior epigastric vessel portion is preferably formed of a silicone resin such as silicone resin A. The hose-like hollow body can be formed by extrusion molding with a mandrel.

The pubic bone portion can be formed, e.g., by mixing a liquid material containing 90% by mass of methyl methacrylate, 9% by mass of trimethylolpropane trimethacrylate, a polymerization accelerator such as p-tolyldiethanolamine, and a polymerization initiator such as benzoyl peroxide with an inorganic material such as calcium carbonate, hydroxyapatite, or alumina, and curing the mixture in a mold. The forming procedure is the same as the rectus abdominis muscle portion. The pectineal ligament portion can be formed, e.g., by applying a slightly hard silicone adhesive so as to enclose the pubic bone portion.

Fascia transversalis portion 5 shown in FIG. 2A has the same area as abdominal internal oblique muscle portion 3 shown in FIG. 1C. Fascia transversalis portion 5 is stacked onto abdominal internal oblique muscle portion 3 across transverse abdominal muscle portion 4, and is coupled to the peripheral edge portion of abdominal internal oblique muscle portion 3. As shown in FIG. 1C, abdominal internal oblique muscle portion 3 has been already coupled to transverse abdominal muscle portion 4 in region 3a1 of the peripheral edge portion. Therefore, fascia transversalis portion 5 is directly coupled to transverse abdominal muscle portion 4 in region 3a1, and as a result, fascia transversalis portion 5 is coupled to abdominal internal oblique muscle portion 3. In addition, in a region 3b which is a peripheral edge portion of abdominal internal oblique muscle portion 3 shown in FIG. 1C, fascia transversalis portion 5 is directly coupled to abdominal internal oblique muscle portion 3. The peripheral edge portion of abdominal internal oblique muscle portion 3 is coupled to fascia transversalis portion 5, so that when abdominal internal oblique muscle portion 3 of the manikin is cut open by means of a scalpel or the like, transverse abdominal muscle portion 4 and fascia transversalis portion 5 located on the back side of abdominal internal oblique muscle portion 3 can be observed and touched by fingers, thereby enabling the practice effect to be increased. The silicone adhesive can be preferably used for coupling fascia transversalis portion 5 and transverse abdominal muscle portion 4 to abdominal internal oblique muscle portion 3.

FIG. 2B shows a perspective view of the fascia extraperitoneal portion. The fascia extraperitoneal portion can be formed, e.g., by applying silicone resin A onto the inside of a mold or pouring silicone resin A into the mold, and releasing cured silicon resin A from the mold. The fascia extraperitoneal portion can also enclose the gauze. The fascia extraperitoneal portion enclosing the gauze can be formed by applying silicone resin A onto the mold or pouring silicone resin A into the mold, stacking the gauze before the resin is dried to cure, and applying or pouring silicone resin A onto the gauze.

In the example shown in FIG. 2B, a spermatic cord portion 11 passes through a fascia extraperitoneal portion 10. Spermatic cord portion 11 can pass through fascia extraperitoneal portion 10, further pass through fascia transversalis portion 5, and project outward of the partial manikin in a portion 3c of abdominal internal oblique muscle portion 3 in FIG. 1C. Such a form is preferable in that it is similar to the structure of a human body (male) and the reality of a practice can be improved. Spermatic cord portion 11 is bonded to abdominal internal oblique muscle portion 3 in portion 3c, and the silicone adhesive can be preferably used for bonding.

To be similar to the structure of a human body and to improve the reality of a practice, as shown in FIG. 2B, spermatic cord portion 11 preferably has a ductus deferens portion 11a, and a testicular blood vessel portion 11b. Preferably, spermatic cord portion 11, ductus deferens portion 11a, and testicular blood vessel portion 11b are each a linear body, can be a hose-like hollow body, and are formed of a silicone resin such as silicone resin A. The hose-like hollow body can be formed by extrusion molding with a mandrel. To be similar to the structure of a human body, spermatic cord portion 11 preferably also has a nerve and a lymphatic vessel.

In a human body, a ductus deferens and a testicular blood vessel are enclosed in a spermatic cord, but as shown e.g., in FIG. 2B, spermatic cord portion 11 is released in a portion 11c to expose ductus deferens portion 11a and testicular blood vessel portion 11b. Exposed ductus deferens portion 11a and testicular blood vessel portion 11b are bonded to fascia extraperitoneal portion 10. Such a form is preferable as an anatomical manikin in that the structure of a human body can be grasped visually and immediately. When spermatic cord portion 11 is not released, spermatic cord portion 11 is bonded to fascia extraperitoneal portion 10. The silicone adhesive can be preferably used for bonding.

As shown in FIG. 2B, fascia extraperitoneal portion 10 has the same area as fascia transversalis portion 5 shown in FIG. 2A. Fascia extraperitoneal portion 10 is stacked onto fascia transversalis portion 5, and is coupled to a peripheral edge portion of fascia transversalis portion 5. The peripheral edge portion of fascia transversalis portion 5 is coupled to fascia extraperitoneal portion 10, so that when fascia transversalis portion 5 of the manikin is cut open by means of a scalpel or the like, fascia extraperitoneal portion 10 and spermatic cord portion 11 located on the back side of fascia transversalis portion 5 can be observed and touched by fingers, thereby enabling the practice effect to be increased. The silicone adhesive can be preferably used for coupling fascia extraperitoneal portion 10 to fascia transversalis portion 5.

Preferably, fascia transversalis portion 5 shown in FIG. 2A is coupled to fascia extraperitoneal portion 10 shown in FIG. 2B so that rectus abdominis muscle portion 6, inferior epigastric vessel portion 7, pubic bone portion 8, and pectineal ligament portion 9 are arranged between fascia transversalis portion 5 and fascia extraperitoneal portion 10. When the anatomical manikin of such a form which is similar to the structure of a human body is used, the reality of a practice can be improved.

Three nerve portions 31, 32, and 33 are arranged on abdominal internal oblique muscle portion 3 in the example shown in FIG. 3, and after abdominal internal oblique muscle portion 3 in this state is reversed into the state of FIG. 1C, abdominal internal oblique muscle portion 3 shown in FIG. 1C is arranged on and coupled to abdominal external oblique muscle portion 2 shown in FIG. 1B, so that nerve portions 31, 32, and 33 are arranged between abdominal internal oblique muscle portion 3 and abdominal external oblique muscle portion 2. In addition, of three nerve portions 31, 32, and 33, one nerve portion 33 passes through abdominal internal oblique muscle portion 3 midway and further passes through fascia transversalis portion 5 and fascia extraperitoneal portion 10, and then, in a portion 11d of fascia extraperitoneal portion 10 shown in FIG. 2B, nerve portion 33 can be coupled to fascia extraperitoneal portion 10. Such a form is preferable as an anatomical manikin in that the structure of a human body can be grasped visually and immediately. The silicone adhesive can be preferably used for coupling nerve portion 33 to fascia extraperitoneal portion 10.

FIG. 4 is a perspective view of a peritoneum portion 12. As shown in FIG. 4, peritoneum portion 12 has an intestinal canal portion 13. To represent an intestinal canal which prolapses in an inguinal hernia, intestinal canal portion 13 is preferably a tubular bag-like body having one opening. As shown in FIG. 4, an opening 13a of intestinal canal portion 13 is coupled to peritoneum portion 12. Peritoneum portion 12 can be formed, e.g., by applying silicone resin A onto the inside of a mold or pouring silicone resin A into the mold, and releasing cured silicone resin A from the mold. The peritoneum portion can also enclose the gauze. The peritoneum portion enclosing the gauze can be formed by applying silicone resin A onto the mold or pouring silicon resin A into the mold, stacking the gauze before the resin is dried to cure, and applying or pouring silicone resin A onto the gauze. In addition, to visualize the inside structure of the partial manikin from the abdominal cavity portion side, the peritoneum portion is preferably transparent. With the silicone resin such as silicone resin A, intestinal canal portion 13 can be formed by extrusion molding with a mandrel.

FIG. 2C is a perspective view showing a state that peritoneum portion 12 shown in FIG. 4 is reversed. In FIG. 2C, intestinal canal portion 13 is located on the back side of peritoneum portion 12 (; the skin portion side of the manikin). As shown in FIG. 2C, peritoneum portion 12 has the same area as fascia extraperitoneal portion 10 shown in FIG. 2B, is stacked onto fascia extraperitoneal portion 10, and is coupled to a peripheral edge portion of fascia extraperitoneal portion 10. Peritoneum portion 12 is coupled to the peripheral edge portion of fascia extraperitoneal portion 10, so that when fascia extraperitoneal portion 10 of the manikin is cut open by means of a scalpel or the like, peritoneum portion 12 and intestinal canal portion 13 located on the back side of fascia extraperitoneal portion 10 can be observed and touched by fingers, thereby enabling the practice effect to be increased. The silicone adhesive can be preferably used for coupling fascia extraperitoneal portion 10 to peritoneum portion 12 and for coupling peritoneum portion 12 to intestinal canal portion 13.

Intestinal canal portion 13 is arranged between peritoneum portion 12 and fascia extraperitoneal portion 10, which is preferable as the anatomical manikin of an inguinal hernia in which the intestinal canal ruptures the peritoneum and prolapses onto the fascia extraperitoneal. In addition, intestinal canal portion 13 passes through fascia extraperitoneal portion 10 and the end of intestinal canal portion 13 is arranged on fascia transversalis portion 5, which is useful as the anatomical manikin of an inguinal hernia in which the intestinal canal ruptures the peritoneum and the fascia extraperitoneal and prolapses onto the fascia transversalis. On the other hand, intestinal canal portion 13 passes through fascia extraperitoneal portion 10 and fascia transversalis portion 5 and the end of intestinal canal portion 13 is arranged on abdominal internal oblique muscle portion 3, which has a high use value as the anatomical manikin of an inguinal hernia in which the intestinal canal ruptures the peritoneum, the fascia extraperitoneal, and the fascia transversalis and prolapses onto the abdominal internal oblique muscle.

After coupling peritoneum portion 12, an abdominal cavity portion 14 having the same area as peritoneum portion 12 is stacked onto peritoneum portion 12. FIG. 2D is a diagram showing a state that abdominal cavity portion 14 is formed. Abdominal cavity portion 14 can be formed by applying a silicone resin such as silicone resin A onto the surface of peritoneum portion 12, and drying the silicone resin to cure. Alternatively, abdominal cavity portion 14 can be formed by forming skin portion 1 having slightly large region 1b across region 1a onto which abdominal external oblique muscle portion 2 or the like is stacked, as shown in FIG. 1A, stacking the respective portions to enclosably coat the side wall of the stacked body by region 1b of skin portion 1, pouring silicone resin A onto peritoneum portion 12, and cutting off the extra portion of region 1b of skin portion 1 after curing. To enable the inside structure of the partial manikin to be visualized from the abdominal cavity portion side, abdominal cavity portion 14 is preferably transparent.

The abdominal external oblique muscle portion, the abdominal internal oblique muscle portion, and the transverse abdominal muscle portion are preferably a film body. A muscle includes stacked muscle bundles, and such a form is represented so that the manikin can have reality, but the muscle is represented by one film body, thereby facilitating the manufacture and attachment of the manikin.

In addition, in the example shown in FIG. 1A, skin portion 1 has a cut open portion 1c. In addition, in the example shown in FIG. 1B, abdominal external oblique muscle portion 2 has a cut open portion 22. Further, in the example shown in FIG. 1C, abdominal internal oblique muscle portion 3 has a cut open portion 34. Each of them has the cut open portion, so that the inside structure of the manikin can be observed immediately without cutting open the manikin by means of a scalpel or the like. For instance, in the manikin in which intestinal canal portion 13 passes through fascia extraperitoneal portion 10 and fascia transversalis portion 5 and the end of intestinal canal portion 13 is arranged on abdominal internal oblique muscle portion 3, a state of prolapsing intestinal canal portion 13 can be observed from outside without cutting open skin portion 1, abdominal external oblique muscle portion 2, and abdominal internal oblique muscle portion 3.

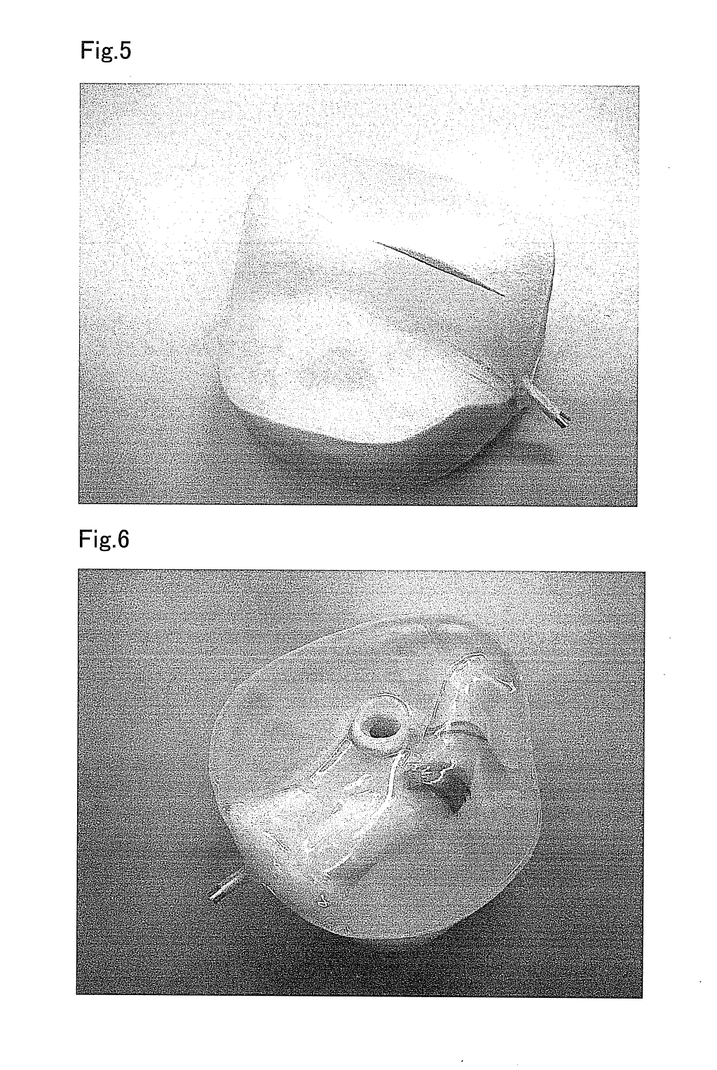

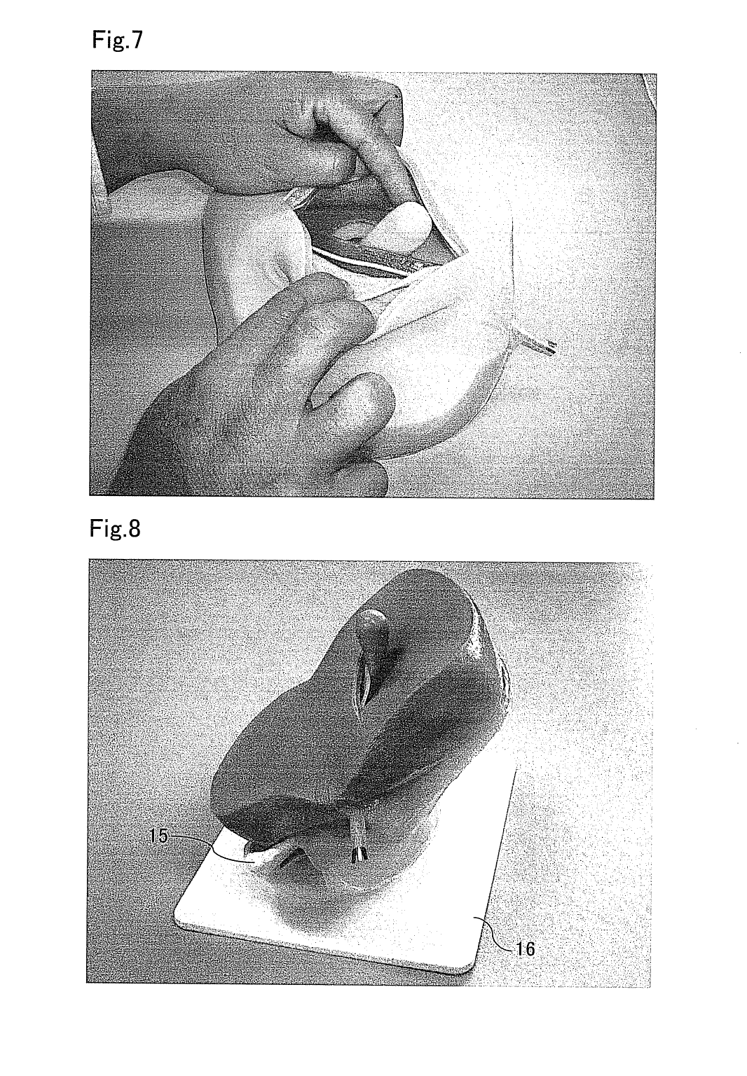

FIG. 5 is a perspective view of the completed human body partial manikin seen from the skin portion side. In the example shown in FIG. 5, the partial manikin has a cut open portion in the right lower direction from the left upper side slightly above the center of the skin portion. FIG. 6 is a perspective view of the completed human body partial manikin seen from the abdominal cavity portion side. In the example shown in FIG. 6, since the abdominal cavity portion is formed of the transparent silicone resin, the ductus deferens portion and the testicular blood vessel portion therein can be observed from outside. FIG. 7 is a perspective view of the cut open human body partial manikin. In the example shown in FIG. 7, a state of cutting open the skin portion, the abdominal external oblique muscle portion, and the abdominal internal oblique muscle portion can be observed. In addition, the intestinal canal portion which passes through the fascia extraperitoneal portion and the fascia transversalis portion to prolapse and a state therearound can be observed.

FIG. 8 is a perspective view showing the human body partial manikin having a pelvis portion. As shown in FIG. 8, a pelvis portion 15 is formed between the peritoneum portion and abdominal cavity portion, so that when an anatomical practice is performed, the partial manikin can be placed on a dissecting table 16 so as to be stood slantly. The partial manikin is stood slantly, which is very similar to a hernia portion, that is, a lower abdomen, when an inguinal hernia patient having an actual operation lies on the back on an operating table. Therefore, a feeling at the time of touching the manikin of each organ can be brought to a feeling at the time of an actual operation performed on a human body more closely when the partial manikin is stood on the dissecting table than when the partial manikin is laid down onto the dissecting table. Therefore, the practice can be made realistic and faithfully reflect an actual operation.

The pelvis portion can be formed, e.g., by mixing a liquid material containing 90% by mass of methyl methacrylate, 9% by mass of trimethylolpropane trimethacrylate, a polymerization accelerator such as p-tolyldiethanolamine, and a polymerization initiator such as benzoyl peroxide with an inorganic material such as calcium carbonate, hydroxyapatite, or alumina, and curing the mixture in the mold. In addition, the silicone adhesive can be preferably used for joining the peritoneum portion and the abdominal cavity portion to the pelvis portion.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A human body partial manikin used in the anatomical practice of an inguinal hernia and representing the structure of a lower abdomen of a human body, comprising:
a skin portion enclosing a gauze;
an abdominal external oblique muscle portion which is stacked onto the skin portion, and is coupled to the skin portion in a peripheral edge portion of a region onto which the abdominal external oblique muscle portion is stacked, and encloses the gauze;
an abdominal internal oblique muscle portion which has the same area as the abdominal external oblique muscle portion, is stacked onto the abdominal external oblique muscle portion, is coupled to a peripheral edge portion of the abdominal external oblique muscle portion, and encloses the gauze;
a transverse abdominal muscle portion which is smaller than the abdominal internal oblique muscle portion, is stacked onto part of the abdominal internal oblique muscle portion, and is coupled to a peripheral edge portion of the abdominal internal oblique muscle portion;
a fascia transversalis portion which has the same area as the abdominal internal oblique muscle portion, is stacked onto the abdominal internal oblique muscle portion across the transverse abdominal muscle portion, and is coupled to a peripheral edge portion of the abdominal internal oblique muscle portion;
a fascia extraperitoneal portion which has the same area as the fascia transversalis portion, is stacked onto the fascia transversalis portion, and is coupled to a peripheral edge portion of the fascia transversalis portion;
a peritoneum portion which has the same area as the fascia extraperitoneal portion, is stacked onto the fascia extraperitoneal portion, is coupled to a peripheral edge portion of the fascia extraperitoneal portion, and has an intestinal canal portion; and
an abdominal cavity portion which has the same area as the peritoneum portion and is stacked onto the peritoneum portion,
wherein the respective portions are formed of a silicone resin.

2. The human body partial manikin according to claim 1, wherein the abdominal external oblique muscle portion, the abdominal internal oblique muscle portion, and the transverse abdominal muscle portion are a film body.

3. The human body partial manikin according to claim 1, wherein the intestinal canal portion passes through the fascia extraperitoneal portion and the fascia transversalis portion.

4. The human body partial manikin according to claim 1, wherein the skin portion, the abdominal external oblique muscle portion, and the abdominal internal oblique muscle portion have a cut open portion.

5. The human body partial manikin according to claim 1, wherein the silicone resin is formed of:
65% by mass to 80% by mass of polydimethylsiloxane;
1% by mass to 30% by mass of a crosslinking agent containing at least one of tetraethoxysilane and ethyl silicate;
3% by mass to 15% by mass of a tin catalyst containing di-n-butyltin dilaurate; and
1% by mass to 10% by mass of powder silica.

6. The human body partial manikin according to claim 1, wherein the skin portion includes an epidermis portion, an endothelium portion, and a subcutaneous fat portion.

7. The human body partial manikin according to claim 1, further comprising an inguinal ligament portion between the abdominal external oblique muscle portion and the abdominal internal oblique muscle portion.

8. The human body partial manikin according to claim 1, further comprising a nerve portion between the abdominal internal oblique muscle portion and the abdominal external oblique muscle portion, at least one nerve portion passing through the abdominal internal oblique muscle portion, the fascia transversalis portion, and the fascia extraperitoneal portion.

9. The human body partial manikin according to claim 1, further comprising a rectus abdominis muscle portion, an inferior epigastric vessel portion, a pubic bone portion, and a pectineal ligament portion between the fascia transversalis portion and the fascia extraperitoneal portion.

10. The human body partial manikin according to claim 1, further comprising a spermatic cord portion which passes through the fascia extraperitoneal portion and the fascia transversalis portion and projects outward of the partial manikin in the abdominal internal oblique muscle portion, the spermatic cord portion having a ductus deferens portion and a testicular blood vessel portion.

11. The human body partial manikin according to claim 1, further comprising a pelvis portion between the peritoneum portion and the abdominal cavity portion.
